(19) United States
(12) Patent Application Publication
(10) Pub. No.: US 2018/0124063 A1
(43) Pub. Date: May 3, 2018

(54) COMPOSITE SECURITY IDENTIFIER

(71) Applicant: Motorola Mobility LLC, Chicago, IL (US)

(72) Inventors: Sudhir Vissa, Bensenville, IL (US); Binesh Balasingh, Naperville, IL (US); Vivek Tyagi, Chicago, IL (US)

(21) Appl. No.: 15/342,531

(22) Filed: Nov. 3, 2016

(51) Int. Cl. H04L 29/06

(52) U.S. Cl. CPC H04L 63/105; H04L 63/06

(57) ABSTRACT

A method includes receiving a composite security identifier associated with a remote device in a local device. A plurality of identification codes associated with the remote device are encoded in the composite security identifier. An access request from the remote device is received in the local device. The access request is associated with a first one of the plurality of identification codes. The remote device is challenged for a second one of the plurality of identification codes different than the first one of the identification codes. An access level for the remote device is set on the local device based on the composite security identifier and the challenging of the remote device. The access request is selectively executed or denied based on the access level.

### BACKGROUND

### Field of the Disclosure

The disclosed subject matter relates generally to computing systems and, more particularly, to employing a composite security identifier for a device including a plurality of individual identification codes.

### Description of the Related Art

Various techniques may be employed for identifying a device as a trusted device. Example approaches use unique identifiers established during manufacture, public identification keys or signed third party keys. Based on the trusted status of a remote device, a local device may allow different levels of access. While these approaches may provide a level of confidence for a particular device identity, they do not provide information regarding the identity of a user of the device.

The present disclosure is directed to various methods and devices that may solve or at least reduce some of the problems identified above.

### BRIEF DESCRIPTION OF THE DRAWINGS

The present disclosure may be better understood, and its numerous features and advantages made apparent to those skilled in the art by referencing the accompanying drawings.

FIG. 1 is a simplified block diagram of a computing system employing composite device identifiers for determining access levels across devices, according to some embodiments disclosed herein;

FIG. 2 is a flow diagram of a method for determining access levels for a remote device using a composite device identifier, according to some embodiments disclosed herein; and

FIG. 3 is a diagram illustrating device and user confidence metrics associated with a composite device identifier, according to some embodiments disclosed herein.

The use of the same reference symbols in different drawings indicates similar or identical items.

### DETAILED DESCRIPTION OF EMBODIMENT(S)

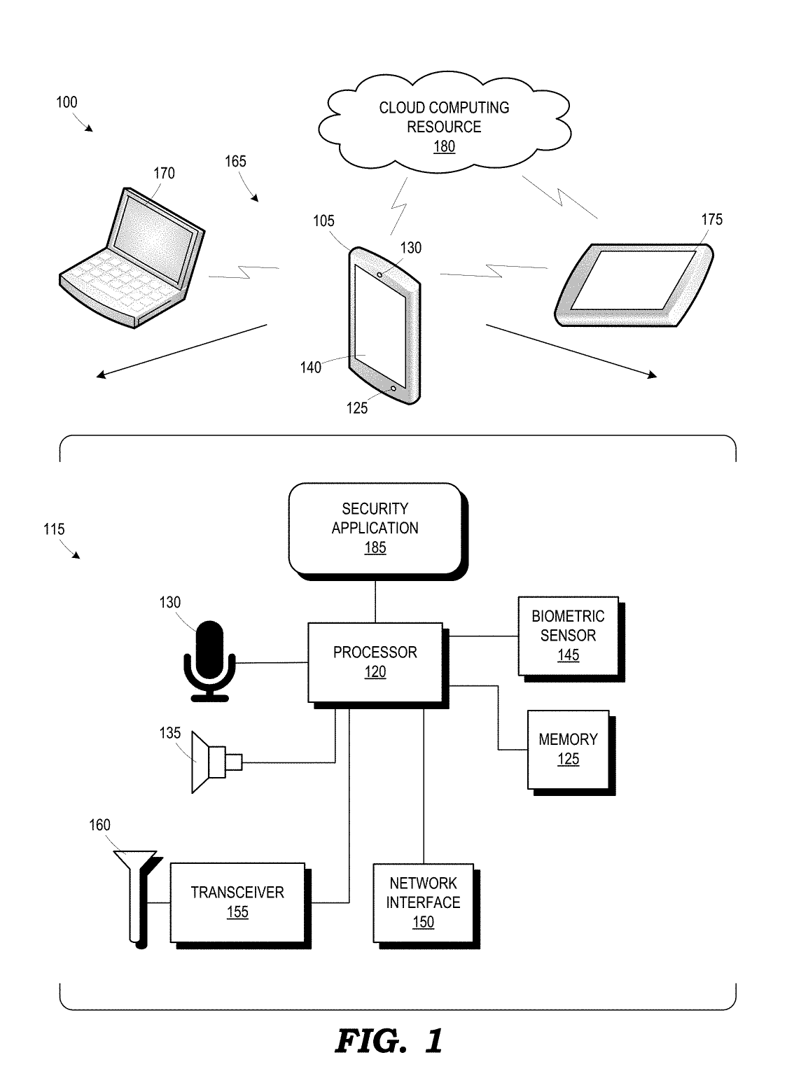

FIGS. 1-3 illustrate example techniques for employing composite device identifiers for determining access levels across devices. To enhance security, a composite security identifier is generated that includes multiple identification codes associated with a device. The identification codes may include hardware identification codes, software identification codes, user identification codes, etc. To validate the identity of a remote device, a local device may challenge the remote device using one or more of the identification codes. For example, an incoming request may be associated with one of the device identifiers associated with the device and the challenge may involve a different device identifier. Based on a confidence factor associated with the composite security identifier, the local device may determine an access level for the remote device. The composite security identifier may be exchanged during a pairing process out-of-band with respect to the normal communication channels employed by the local and remote devices. The pairing may be repeated based on changes to the composite security identifier, for example, if additional identification codes are added to increase the confidence factor.

FIG. 1 is a simplistic block diagram of a communications system 100 including a first device 105. The first device 105 implements a computing system 115 including, among other things, a processor 120, a memory 125, a microphone 130, a speaker 135, a display 140, a biometric sensor 145 (e.g., fingerprint sensor, retinal scanner, etc.), network interface 150, a transceiver 155, and an antenna 160. The memory 120 may be a volatile memory (e.g., DRAM, SRAM), a non-volatile memory (e.g., ROM, flash memory, hard disk, etc.), or some combination thereof. The transceiver 155 transmits and receives signals via the antenna 160. The transceiver 155 may include one or more radios for communicating according to different radio access technologies, such as cellular, Wi-Fi, Bluetooth®, etc. The network interface 150 is intended to represent an interface for implementing the communication link using a hardwired connection. Although a mobile device may not typically include a network interface 150, it is illustrated as an example of an alternative communication means. Using the transceiver 155 or the network interface 150, the device 105 implements a communication link 165. The communication link 165 may have a variety of forms. In some embodiments, the communication link 165 may be a wireless radio or cellular radio link. The communication link 165 may also communicate over a packet-based communication network, such as the Internet.

As illustrated in FIG. 1, the first device 105 may be one of a plurality of connected devices 105, 170, 175. The other connected devices 170, 175 may also include a computing system having some or all of the entities in the computing system 115 of the first device 105. Any number of connected devices of different types may be included when using the method and systems disclosed herein. In various embodiments, the devices 105, 170, 175 may be embodied in handheld or wearable devices, such as laptop computers, handheld computers, tablet computers, mobile devices, telephones, personal data assistants, music players, game devices, wearable computing devices and the like. One or more of the connected devices 170, 175 could also be a non-portable device, such as a desktop computer. For example, the device 170 may be a laptop computer and the device 175 may be a tablet computer. To the extent certain example aspects of the devices 105, 170, 175 are not described herein, such example aspects may or may not be included in various embodiments without limiting the spirit and scope of the embodiments of the present application as would be understood by one of skill in the art. The devices 105, 170, 175 may or may not be associated with the same user.

As described in greater detail herein, the devices 105, 170, 175 may exchange composite security identifiers and employ these identifiers in a secure environment for determining access levels across the devices. In some embodiments, a cloud computing resource 180 may interface with the devices 105, 170, 175 to facilitate the exchange of the composite security identifiers between some or all of the devices 105, 170, 175, as described herein.

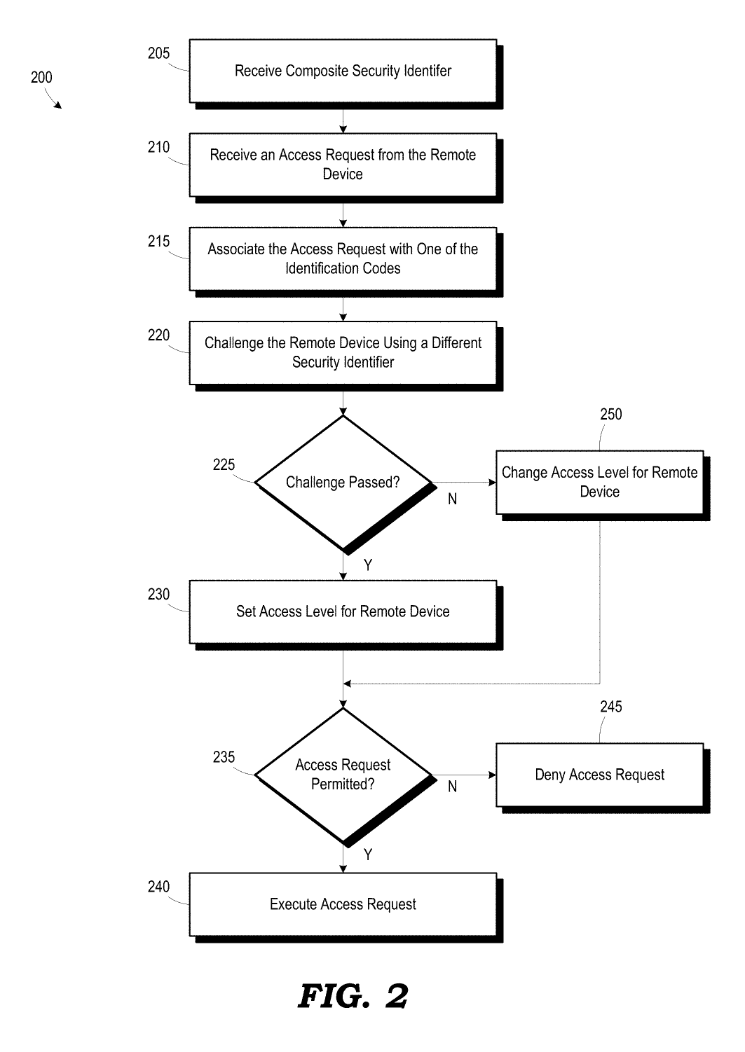

In the first device 105, the processor 120 may execute instructions stored in the memory 125 and store information in the memory 125, such as the results of the executed instructions. Some embodiments of the processor 120 and the memory 125 may be configured to implement a security application 185 and perform portions of the method 200 shown in FIG. 2 and discussed below. For example, the processor 120 may execute the security application 185 to receive a composite security identifier from one or both of the devices 170, 175 (i.e., remote devices) and set access levels for the associated device 170, 175 with respect to resources of the device 105 (i.e., local device). In general, one or more of the devices 105, 170, 175 may be capable of implementing various elements of the method shown in FIG. 2. In one example, various elements of the methods may be implemented on the device 105. In some embodiments, the cloud computing resource 180 may also be used to perform one or more elements of the method 200.

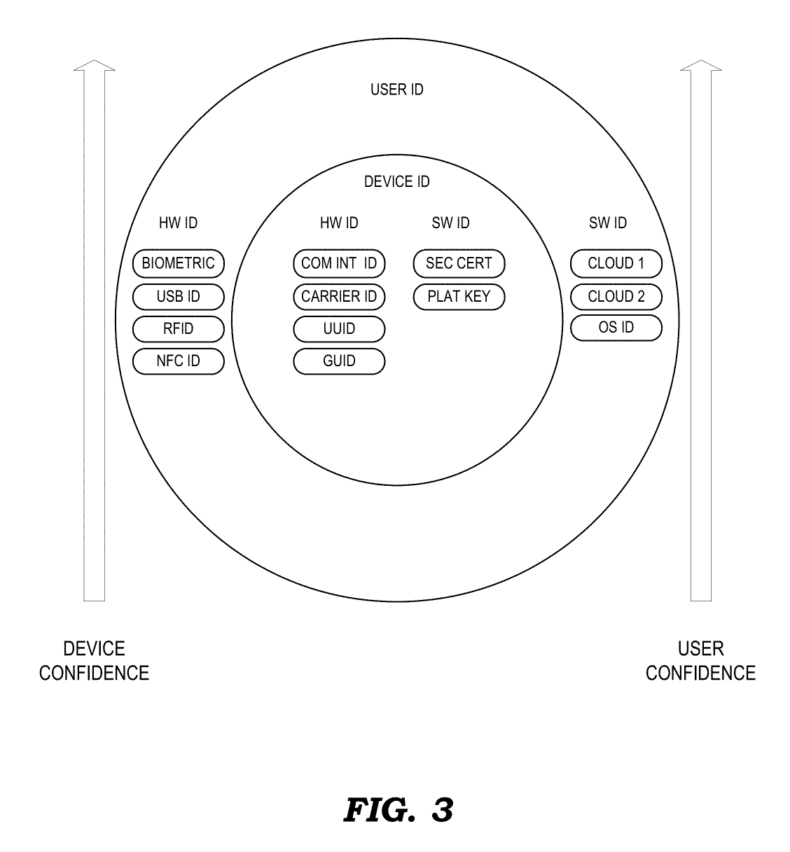

The composite security identifier employed by the security application 185 may have a variety of components. FIG. 3 is a diagram illustrating example device and user identification codes that may be employed to construct the composite security identifier. In some embodiments, the composite security identifier includes both device identification codes and user identification codes. The identification codes may also be hardware identification codes or software identification codes in either device or user category.

Example hardware device identification codes include a communication interface identification code (e.g., media access control (MAC) address, BLUETOOTH® address, BLUETOOTH® name, etc.), a carrier identification code (e.g., international mobile station equipment identity (IMEI) identifier, mobile equipment identifier (MEID)), a universally unique identifier (UUID), a globally unique identifier (GUID), a trusted platform (TPM) key, a trusted zone (TZ) key, etc.

Example software device identification codes include a security certificate, a platform provided key (e.g., cryptography next generation (CNG) key), etc.

Example hardware user identification codes include a hardware key not native to the device, such as a biometric ID, a USB drive ID, a radio frequency identification (RFID) tag ID, a near field communications (NFC) tag ID, etc.

Example software user identification codes include a cloud account login identification code (e.g., FACEBOOK®, TWITTER®, GOOGLE®, APPLE®, MICROSOFT®, etc.), an operating system user ID, etc.

In general, the number and type of the identification codes contribute to a confidence level associated with the composite security identifier. Based on the confidence factors, the security application 185 sets access levels for the device 105 with respect to requests from the other devices 170, 175. Table 1 provides an example set of access levels, where Level 1 is considered the highest access level.

TABLE 1
Access Levels

| | | Level | Level | Level | Level |
|---|---|---|---|---|---|
| | Feature | 1 | 2 | 3 | 4 |
| Apps | View | ✓ | ✓ | ✓ | X |
| | Share | ✓ | ✓ | X | X |
| | Update | ✓ | X | X | X |
| | Delete | ✓ | X | X | X |
| System Settings | View | ✓ | ✓ | ✓ | X |
| | Share | ✓ | ✓ | X | X |
| | Update | ✓ | X | X | X |
| App Data | View | ✓ | ✓ | ✓ | ✓ |
| | Update | ✓ | X | X | X |
| | Delete | ✓ | X | X | X |
| User Profiles | View | ✓ | ✓ | ✓ | X |
| | Share | ✓ | ✓ | X | X |
| | Delete | ✓ | X | X | X |
| Content | View/Download | ✓ | ✓ | ✓ | ✓ |
| | Create/Upload | ✓ | ✓ | X | X |
| | Delete | ✓ | X | X | X |
| | Share/Sync | ✓ | ✓ | X | X |
| | Set/Restrict Access | ✓ | X | X | X |
| | Permissions | | | | |
| Tasks | View/Download | ✓ | ✓ | ✓ | X |
| | Create/Upload | ✓ | ✓ | X | X |
| | Delete | ✓ | X | X | X |
| | Share/Sync | ✓ | ✓ | X | X |
| | Set/Restrict Access | ✓ | X | X | X |
| | Permissions | | | | |

FIG. 2 is a flow diagram of an illustrative method 200 for determining access levels for a remote device 170, 175 using a composite device identifier, according to some embodiments disclosed herein. In method block 205, a composite security identifier is received from a remote device 170, 175 in a local device 105. A plurality of identification codes associated with the device are encoded in the composite security identifier. For example, the set of available identification codes illustrated in FIG. 3 for a particular device 170, 175 and user may be concatenated and encrypted to generate the composite security identifier. In some embodiments, the composite security identifier may be exchanged using an out-of-band (OOB) technique, where the normal communication channels for communicating between the devices 105, 170, 175 are not employed. For example, one of the remote devices 170, 175 may communicate with a third party resource (e.g., using the cloud computing resource 180 by navigating to a particular web address or by scanning a quick response (QR) code) to exchange information necessary to construct the composite security identifier. The third party resource may then communicate the composite security identifier to the device 105 for use by the security application 185. The user may interact with the third party information to provide one or more of the identification codes. The use of an OOB technique reduces the likelihood that a malicious party could provide a false composite security identifier to gain privileged access to the device 105.

In method block 210, the security application 185 receives an access request from the remote device. The access request may be associated with accessing, changing or adding data stored on the device 105, using a resource of the device 105, etc.

In method block 215, the security application 185 associates the access request with one of the identification codes in the composite security identifier. For example, the network interface identification code or a user ID may be embedded in the access request or it may be discernible based on other information in the access request.

In method block 220, the security application 185 challenges the remote device using a different security identifier in the composite security identifier. For example, the security application 185 may challenge the remote device 170, 175 to provide a different type of security identifier than the one used to associate the access request with the composite security identifier. In one embodiment, if a device hardware security identifier is used for association, a user hardware or software security identifier may be used for the challenge. In some embodiments, the security identifier selected for challenging the remote device 170, 175 may be randomized. The challenging of the remote device 170, 175 may be conducted for each session, for each access request, periodically, etc. The number of successful challenges may be a metric used to determine a confidence metric associated with the remote device 170, 175. In some embodiments, the remote device 170, 175 may automatically respond to the challenge, while in other embodiments the user of the remote device 170, 175 may be queried to provide the challenge response.

If the remote device 170, 175 passes the challenge in method block 225, the security application 185 sets an access level for the remote device 170, 175 in method block 230. The access level may be dependent on the robustness of the composite security identifier (e.g., the number and types of security identifiers embedded therein). The access level may also be associated with a count of successful challenges.

In method block 235, the security application 185 determines if the access request is permitted based on the access level of the remote device 170, 175. If the access request is permitted, the access request is executed by the processor 120 in method block 240. If the access request is not permitted in method block 235, the security application 185 denies the access request in method block 245. For some subsequent access requests from the remote device 170, 175, the challenge method blocks 220, 225, 230 may be omitted. The challenge method blocks 220, 225, 230 may be periodically performed to maintain the confidence level associated with the remote device 170, 175.

If the challenge request is failed by the remote device 170, 175 in method block 225, the access level for the remote device 250 is changed in method block 250. Changing the access level may include reducing a previously established access level, setting a minimum access level, or blocking the remote device 170, 175 (i.e., no access level).

In some embodiments, certain aspects of the techniques described above may be implemented by one or more processors of a processing system executing software. The method 200 described herein may be implemented by executing software on a computing device, such as the processor 120 of FIG. 1, however, such methods are not abstract in that they improve the operation of the devices 105, 170, 175 and the user's experience when operating the devices 105, 170, 175. Prior to execution, the software instructions may be transferred from a non-transitory computer readable storage medium to a memory, such as the memory 125 of FIG. 1.

The software may include one or more sets of executable instructions stored or otherwise tangibly embodied on a non-transitory computer readable storage medium. The software can include the instructions and certain data that, when executed by one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

A method includes receiving a composite security identifier associated with a remote device in a local device. A plurality of identification codes associated with the remote device are encoded in the composite security identifier. An access request from the remote device is received in the local device. The access request is associated with a first one of the plurality of identification codes. The remote device is challenged for a second one of the plurality of identification codes different than the first one of the identification codes. An access level for the remote device is set on the local device based on the composite security identifier and the challenging of the remote device. The access request is selectively executed or denied based on the access level.

A device includes a memory to store a composite security identifier associated with a remote device and a processor. A plurality of identification codes associated with the remote device are encoded in the composite security identifier. The processor is to receive an access request from the remote device, associate the access request with a first one of the plurality of identification codes, challenge the remote device for a second one of the plurality of identification codes different than the first one of the identification codes, set an access level for the remote device based on the composite security identifier and the challenging of the remote device, and selectively execute or deny the access request based on the access level.

The particular embodiments disclosed above are illustrative only, as the invention may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the invention. Note that the use of terms, such as “first,” “second,” “third” or “fourth” to describe various processes or structures in this specification and in the attached claims is only used as a shorthand reference to such steps/structures and does not necessarily imply that such steps/structures are performed/formed in that ordered sequence. Of course, depending upon the exact claim language, an ordered sequence of such processes may or may not be required. Accordingly, the protection sought herein is as set forth in the claims below.

What is claimed is:

1. A method, comprising:
receiving a composite security identifier associated with a remote device in a local device, wherein a plurality of identification codes associated with said remote device are encoded in said composite security identifier;
receiving an access request from said remote device in said local device;
associating said access request with a first one of said plurality of identification codes;
challenging said remote device for a second one of said plurality of identification codes different than said first one of said plurality of identification codes;
setting an access level for said remote device on said local device based on said composite security identifier and said challenging of said remote device; and
selectively executing or denying said access request based on said access level.

2. The method of claim 1, wherein setting said access level comprises setting said access level based on a count of identification codes in said plurality of identification codes.

3. The method of claim 1, further comprising repeating said challenging using different ones of said plurality of identification codes and increasing said access level based on a count of the challenges.

4. The method of claim 1, further comprising denying said access request responsive to said remote device failing the challenge.

5. The method of claim 1, wherein said plurality of identification codes comprises a device identification code.

6. The method of claim 5, wherein said device identification code comprises one of a communication interface identification code, a device user login identification code, or a communication network identification code.

7. The method of claim 1, wherein said plurality of identification codes comprises a user identification code.

8. The method of claim 7, wherein said user identification code comprises one of a biometric identification code or a remote service user identification code.

9. The method of claim 1, wherein said plurality of identification codes comprises at least one user identification code and at least one device identification code, and the method further comprises:
generating a user confidence factor based on said plurality of identification codes;
generating a device confidence factor based on said plurality of identification codes; and
setting said access level based on said user confidence factor and said device confidence factor.

10. The method of claim 9, wherein setting said access level comprises selecting one of a plurality access levels in a hierarchy of access levels based on said user confidence factor and said device confidence factor.

11. A device, comprising:
a memory to store a composite security identifier associated with a remote device, wherein a plurality of identification codes associated with said remote device are encoded in said composite security identifier; and
a processor to receive an access request from said remote device, associate said access request with a first one of said plurality of identification codes, challenge said remote device for a second one of said plurality of identification codes different than said first one of said plurality of identification codes, set an access level for said remote device based on said composite security identifier and said challenging of said remote device, and selectively execute or deny said access request based on said access level.

12. The device of claim 11, wherein said processor is to set said access level based on a count of identification codes in said plurality of identification codes.

13. The device of claim 11, wherein said processor is to repeat said challenging using different ones of said plurality of identification codes, and increase said access level based on a count of said challenges.

14. The device of claim 11, wherein said processor is to deny said access request responsive to said remote device failing said challenge.

15. The device of claim 11, wherein said plurality of identification codes comprises a device identification code.

16. The device of claim 15, wherein said device identification code comprises one of a communication interface identification code, a device user login identification code, or a communication network identification code.

17. The device of claim 11, wherein said plurality of identification codes comprises a user identification code.

18. The device of claim 17, wherein said user identification code comprises one of a biometric identification code or a remote service user identification code.

19. The device of claim 11, wherein said plurality of identification codes comprises at least one user identification code and at least one device identification code, wherein said processor is to generate a user confidence factor based on said plurality of identification codes, generate a device confidence factor based on said plurality of identification codes, and set said access level based on said user confidence factor and said device confidence factor.

20. The device of claim 19, wherein setting said access level comprises selecting one of a plurality of access levels in a hierarchy of access levels based on said user confidence factor and said device confidence factor.
